(19) United States
(12) Patent Application Publication
(10) Pub. No.: US 2008/0306875 A1
(43) Pub. Date: Dec. 11, 2008

(54) METHOD AND SYSTEM FOR SECURE NETWORK CONNECTION

(75) Inventor: Upendra Sharadchandra Mardikar, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 11/761,156

(22) Filed: Jun. 11, 2007

(51) Int. Cl. H04L 9/00

(52) U.S. Cl. 705/71

(57) ABSTRACT

Methods and systems for secure payment via a network are disclosed. In an example embodiment, a system includes components to receive a globally unique identifier (GUID) and a client-hello message from a client, generate a tag and sending the tag and a server hello message to the client, receive the tag, a client-key-exchange message, a change-c-spec message, an encrypted-finished message, and secured payload from the client, and send an encrypted-finished message and secured response payload to the client.

### FIELD

The present application relates generally to the technical field of data-processing and, in one specific example, to a method and system for secure connection via a network.

### BACKGROUND

Persons that access network resources, such as websites, may conduct e-commerce transactions and be involved in other communications where information is transmitted over a network. Transmitting of such information over the network may expose the user to risks of third parties that may seek unauthorized access for nefarious purposes. The third parties may seek such access by obtaining a password or other login information for the network resources.

Operators of the network resources may seek ways to secure their network resources to prevent activity that is not authorized by the users. For example, operators may require users to meet a password criteria such as being of a certain length and/or including special characters or to frequently change their passwords. In other cases, transfers of value in e-commerce transactions must be done in a secure and efficient manner. Conventional systems have been unable to satisfactorily balance security and efficiency in transfers of value in e-commerce transactions.

### BRIEF DESCRIPTION OF THE DRAWINGS

Some embodiments are illustrated by way of example and not limitation in the figures of the accompanying drawings in which:

FIG. 1 illustrates the conventional TLS handshake protocol;

FIG. 2 illustrates the improved secure connection protocol of an example embodiment;

FIGS. 3-4 are flowcharts illustrating the improved secure connection protocol of an example embodiment;

FIG. 5 is a network diagram depicting a network system, according to one embodiment, having a client server architecture configured for exchanging data over a network; and

FIG. 6 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for secure connection via a network are described. In the following description, for purposes of explanation, numerous specific details are set forth in order to provide a thorough understanding of example embodiments. It will be evident, however, to one of ordinary skill in the art that the various embodiments may be practiced without these specific details.

TLS (Transport Layer Security) is a conventional protocol that guarantees privacy and data integrity between client/server applications communicating over the Internet. Conventional TLS protocol is made up of two layers: 1) The TLS Record Protocol—layered on top of a reliable transport protocol, such as TCP, it ensures that the connection is private by using symmetric data encryption and it ensures that the connection is reliable. The TLS Record Protocol also is used for encapsulation of higher-level protocols, such as the TLS Handshake Protocol.; and 2) The TLS Handshake Protocol—allows authentication between the server and client and the negotiation of an encryption algorithm and cryptographic keys before the application protocol transmits or receives any data. TLS is application protocol-independent. Higher-level protocols can layer on top of the TLS protocol transparently. Based on Netscape's SSL 3.0, TLS supersedes and is an extension of SSL; but, TLS and SSL are not interoperable.

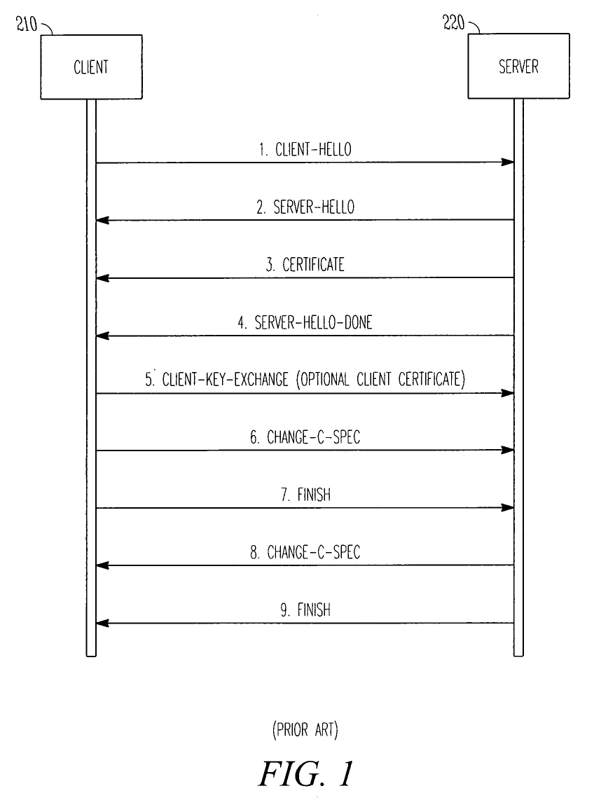

FIG. 1 illustrates a high-level diagram of the standard TLS handshake protocol. As shown, client 210 initiates communication with server 220 by sending a client-hello message to server 220 in step 1. The client 210 can also send the client's random value and supported cipher suites to the server 220 in step 1. In response to the client-hello message, server 220 initiates a server-hello message in step 2. The server 220 can also send the server's random value to the client 210 in step 2. As part of the server-hello message, server 220 sends a certificate for authentication to client 210 in step 3. The certificate can be used by the client 210 to encrypt subsequent communications to the server 220. The server may request a certificate from the client. The server-hello message is completed in step 4 after the server 220 sends a server-hello-done message to client 210. If the server 220 has requested a certificate from the client 210, the client sends the certificate. In step 5, the client 210 creates a random Pre-Master Secret and encrypts it with the public key from the server's 220 certificate. Client 210 sends the encrypted Pre-Master Secret in a client-key-exchange message (with optional client certificate) to server 220 in step 5. The server 220 receives the encrypted Pre-Master Secret from the client 210. The server 220 and client 210 each generate the Master Secret and session keys based on the Pre-Master Secret. In step 6, the client sends a Change-Cipher-Spec notification to server 220 to indicate that the client 210 will start using the new session keys for hashing and encrypting messages. The client 210 also sends a Client-finished message to the server 220 in step 7. The server 220 receives the Change-Cipher-Spec notification from client 210 and switches the server's 220 record layer security state to symmetric encryption using the newly generated session keys. Server 220 sends a Change-Cipher-Spec message to client 210 to acknowledge that the server's 220 record layer security state has been changed in step 8. Server 220 sends a Server-finished message to the client 210 in step 9. At this point, Client 210 and server 220 can now exchange application data over the secured channel they have established using the conventional protocol described above. All messages subsequently sent from client 210 to server 220 and from server 220 to client 210 are encrypted using the newly generated session key.

Although the standard TLS handshake protocol is reasonably secure, the high number of communications necessary between the client and the server to establish a secure communication channel make the conventional protocol inefficient and time-consuming. In other words, the standard TLS handshake protocol includes too many round-trip communications between the client and the server. As such, the standard TLS handshake protocol causes excessive performance overhead.

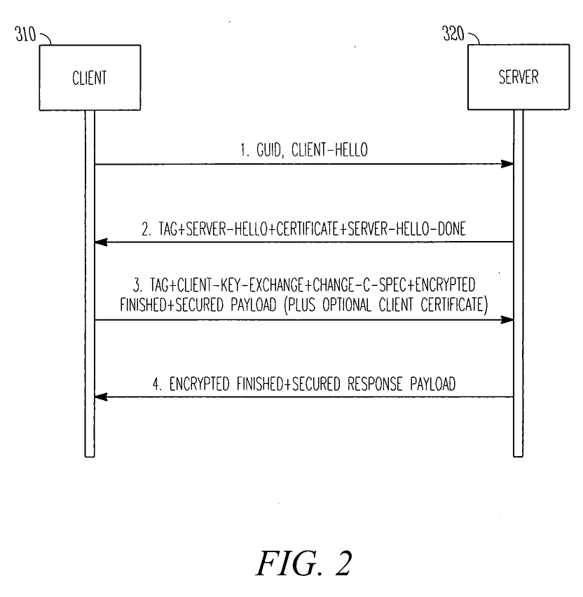

FIG. 2 illustrates a better protocol between a client and a server for establishing a secure connection in an example embodiment. As shown, a client 310 initiates communication with server 320 by sending a client-hello message to server 320 in step 1. In addition, the client 310 generates a globally unique identifier (GUID), which the client 310 sends with the client-hello message to server 320 in step 1. A GUID is a pseudo-random number generated using well-known techniques. In step 1, the server 320 receives the GUID and the corresponding client-hello message. In an example embodiment, server 320 can store the GUID and the corresponding client-hello message in a database accessible to other related servers. In this manner, the server 320 can be part of a bank of load-balanced servers. A tag can be generated by server 320 to identify a location in the database where the GUID and the corresponding client-hello message are stored. The server 320 sends this tag with a server-hello message, a certificate, and a server-hello-done message to the client 310 in step 2.

In response to the tag with the server-hello message, certificate, and server-hello-done message received from server 320, client 310, in step 3, creates a random Pre-Master Secret and encrypts it with the tag from the server's 320 server-hello message. Client 310 prepares a message for server 320 including the encrypted Pre-Master Secret and a client-key-exchange message. The client 310 also generates a Master Secret and session keys based on the Pre-Master Secret. In step 3, the client 310 adds a Change-Cipher-Spec notification to the message being prepared for server 320. The client 310 also adds an Encrypted-finished message to the message being prepared for server 320 in step 3. Finally, client 310 can encrypt a payload with the generated session keys and add the secured payload to the message being prepared for server 320 in step 3. The prepared message with the tag, client-key-exchange message, Change-Cipher-Spec notification, Encrypted-finished message, the secured payload, and optionally a client certificate is sent to the server 320 in step 3.

In response to the message sent to the server 320 in step 3, the server 320 receives the Change-Cipher-Spec notification from client 310 and switches the server's 320 record layer security state to symmetric encryption using the newly generated session keys. In step 4, the server 320 prepares a message for client 310 including an Encrypted-finished message. Additionally, the server 320 can encrypt a response payload for the client 310 using the newly generated session keys. This secured response payload can be added to the message being prepared for the client 310 at step 4. The prepared message including an Encrypted-finished message and the secured payload response can be sent to the client 310 in step 4. At this point, Client 310 and server 320 can now exchange application data over the secured channel they have established using the improved protocol described above. All messages subsequently sent from client 310 to server 320 and from server 320 to client 310 are encrypted using the newly generated session key.

The use of the method and system described herein may enable enhanced authentication for access, such as transactions that a user may have with network resources such as websites, financial institutions, or the like. For example, the improved security protocol may increase the efficiency of the communications between a client and a server while providing a reasonable level of security.

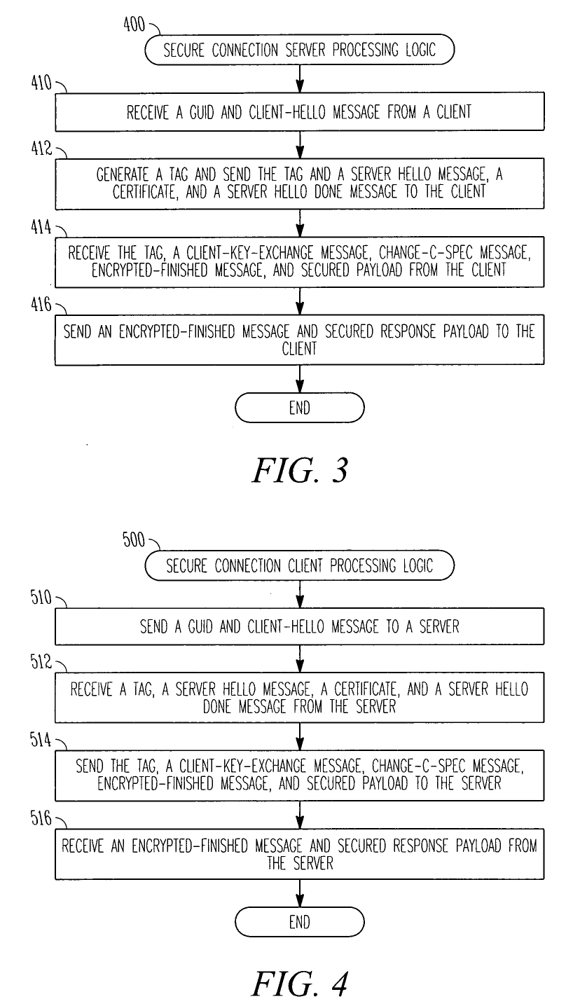

FIGS. 3-4 are flowcharts illustrating the improved secure connection protocol of an example embodiment. FIG. 3 illustrates the protocol from the server perspective. FIG. 4 illustrates the protocol from the client perspective.

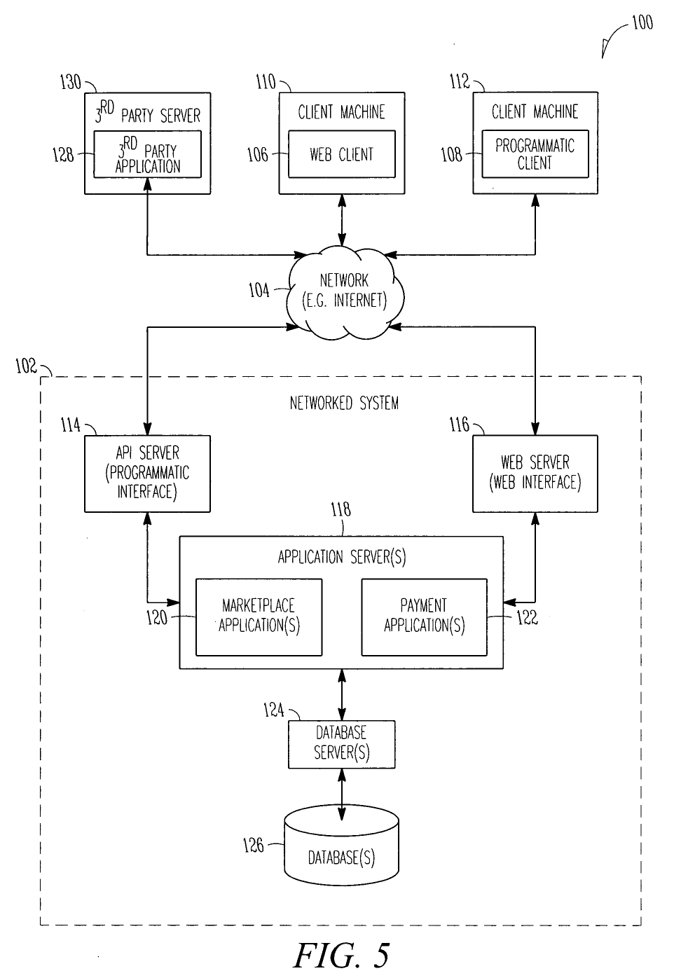

FIG. 5 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 5 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Programming Interface (API) server 114 and a web server 116 are coupled to, and provide programmatic and web interfaces respectively to, one or more application servers 118. The application servers 118 host one or more marketplace applications 120 and payment applications 122.The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for items (e.g., products or services) that are made available via the marketplace applications 120. While the marketplace and payment applications 120 and 122 are shown in FIG. 5 to both form part of the networked system 102, it will be appreciated that, in alternative embodiments, the payment applications 122 may form part of a payment service that is separate and distinct from the networked system 102.

Further, while the system 100 shown in FIG. 5 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 5 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

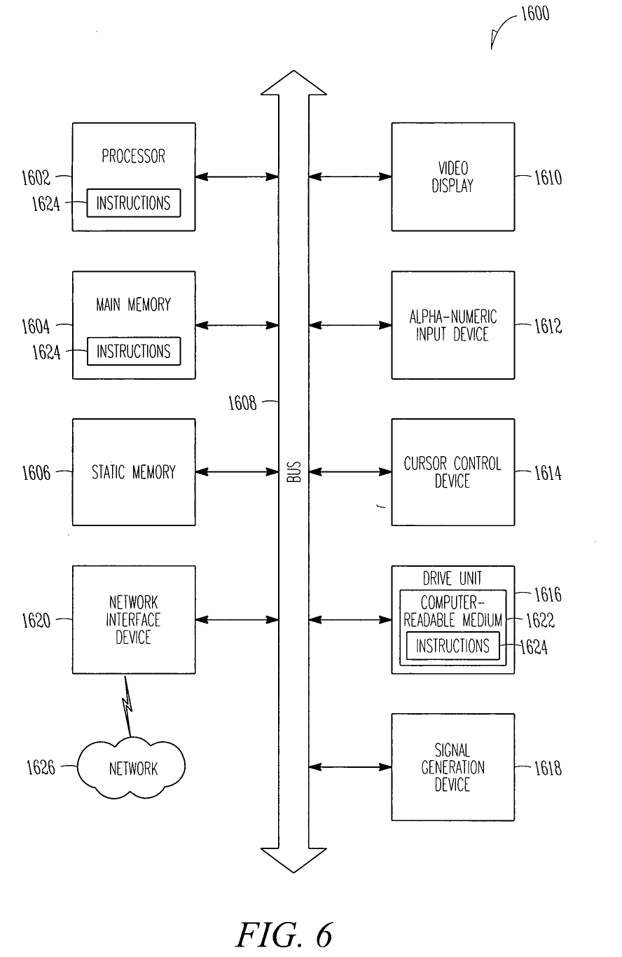

FIG. 6 shows a diagrammatic representation of machine in the exemplary form of a computer system 1600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1600 includes a processor 1602 (e.g., a central processing unit (CPU) a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a cursor control device 1614 (e.g., a mouse), a disk drive unit 1616, a signal generation device 1618 (e.g., a speaker) and a network interface device 1620.

The disk drive unit 1616 includes a machine-readable medium 1622 on which is stored one or more sets of instructions (e.g., software 1624) embodying any one or more of the methodologies or functions described herein. The software 1624 may also reside, completely or at least partially, within the main memory 1604 and/or within the processor 1602 during execution thereof by the computer system 1600, the main memory 1604 and the processor 1602 also constituting machine-readable media.

The software 1624 may further be transmitted or received over a network 1626 via the network interface device 1620.

While the machine-readable medium 1622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, methods and systems for secure payment via a network have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A server system comprising:
a first component to receive a globally unique identifier (GUID) and a client-hello message from a client;
a second component to generate a tag and send the tag and a server hello message to the client;
a third component to receive the tag, a client-key-exchange message, a change-c-spec message, an encrypted-finished message, and secured payload from the client; and
a fourth component to send an encrypted-finished message and secured response payload to the client.

2. The system of claim 1 further including a fifth component to generate a session key.

3. A client system comprising:
a first component to send a globally unique identifier (GUID) and a client-hello message to a server;
a second component to receive a tag and a server hello message from the server;
a third component to send the tag, a client-key-exchange message, a change-c-spec message, an encrypted-finished message, and secured payload to the server; and
a fourth component to receive an encrypted-finished message and secured response payload from the server.

4. The system of claim 3 further including a fifth component to generate a session key.

5. A method comprising:
receiving a globally unique identifier (GUID) and a client-hello message from a client;
generating a tag and sending the tag and a server hello message to the client;
receiving the tag, a client-key-exchange message, a change-c-spec message, an encrypted-finished message, and secured payload from the client; and
sending an encrypted-finished message and secured response payload to the client.

6. The method of claim 5 further including generating a session key.

7. A machine-readable medium comprising instructions, which when executed by a machine, cause the machine to:
receive a globally unique identifier (GUID) and a client-hello message from a client;
generate a tag and sending the tag and a server hello message to the client;
receive the tag, a client-key-exchange message, a change-c-spec message, an encrypted-finished message, and secured payload from the client; and
send an encrypted-finished message and secured response payload to the client.

8. The machine-readable medium of claim 7 further including instructions operable to generate a session key.
